(19) United States
(12) Patent Application Publication
(10) Pub. No.: US 2008/0177718 A1
(43) Pub. Date: Jul. 24, 2008

(54) User Interface with Fields for Entries to be Applied to Heterogeneous Processes

(76) Inventors: Laurent Hasson, New York, NY (US); David Konopnicki, Haifa (IL)

Correspondence Address: Stephen C. Kaufman;IBM CORPORATION, Intellectual Property Law Dept., P. O. Box 218, Yorktown Heights, NY, 10598, US

(21) Appl. No.: 11/625,824

(22) Filed: Jan. 23, 2007

(51) Int. Cl. G06F 3/048; G06F 17/30

(52) U.S. Cl. 707/4; 715/700; 707/E17.014

(57) ABSTRACT

A method and system for providing a user interface (320, 420, 520, 620) with input fields to be applied to a plurality of processes (301-304, 401-404, 501-504, 601-604). In one embodiment, the user interface is a search user interface (320, 420) and the processes are searchable applications (301-304, 401-404). In another embodiment, the user interface is a workflow form (520, 620) and the processes are workflow steps (501-504, 601-604). The method includes defining a set of basic fields (312, 465, 512, 635). Each process (301-304, 401-404, 501-504, 601-604) provides a set of process fields (331-334, 462, 531-534, 632) and each process field is either mapped (314, 467, 514, 637) to a basic field or defined as a process-specific field. A user interface (320, 420, 520, 620) is generated including a set of basic fields (322, 522) for input parameters which define the intersection of the common fields of the plurality of processes, and one or more sets (323, 324, 523, 524) of process-specific fields for input parameters.

### FIELD OF THE INVENTION

This invention relates to the field of user interfaces with fields for entries to be applied to heterogeneous processes.

### BACKGROUND OF THE INVENTION

User interfaces with input fields which define the parametric inputs to a system, are used in many different environments. As an example, a search system may have a user interface with fields for input of parameters of searching criteria. As another example, a workflow system may have a user interface for input of values of inputs or outputs of the workflow process steps. The following discussion of the background is provided in the context of searching systems in order to illustrate the problems of the current art.

Search functionality has in the past been implemented by individual applications independently. For example, a search in email, a search in a file system, a search in code files, etc. The search system is now becoming a system-level service that different applications can use to store their data and make it searchable. Search indexes are becoming foundation services provided on a desktop, as part of the operating system of personal computers, or enterprise servers.

A search facility can be provided on a desktop of a personal computer. An example is Google Desktop Search (trade mark of Google Inc.) which provides searches and access to information on a personal computer. It is a desktop search application that provides full text search over documents including: email, instant messages, computer files, media files such as music, video and photos, and web pages that have been viewed.

System-wide search engines can also be provided as part of an operating system of a computer. For example, Spotlight in Mac OS X v10.4 Tiger (Spotlight, Mac and Tiger are trade marks of Apple Computer Inc.) and Longhorn (trade mark of Microsoft Corporation) provide search facilities as part of their operating systems in which applications and documents can be searched.

System-wide search engines are also used in enterprise search environments. For example, IBM OmniFind (IBM and OmniFind are trade marks of International Business Machines Corporation) is an enterprise search middleware that searches intranets, extranets, corporate public web sites, relational database systems, file systems, and a wide range of disparate content repositories.

Applications running on such systems do not implement their search features independently, as done in the past but, instead, index their data as part of a global search index of the search system. For example, an instant messaging application that wants to provide a searchable history of messages does not need to implement this feature but must push the messages to the global index provided by the search service. In order to do so, providers of search technology publish application programming interfaces (APIs) that allow applications to push their data into their full-text global index.

The items added to indexes have different fields like author, title, last updated date, etc. Some of the fields are common to all the applications and some are application specific.

To search, users are usually presented with a user interface (UI) they can use to build parametric queries. Thus, the problem is to determine the list of fields to display in such a UI when the search will be submitted to a search index containing applications data that define different fields. For example, if the index contains an author field for documents and a sender field for emails it is a problem as to which field should be presented in the UI.

There are two current approaches to search UIs for searching over heterogeneous resources. The first is to provide a fixed list of fields. All the other fields must be defined in the query text. The second approach is to provide an API to build customised search UIs for specific applications which are being searched.

### SUMMARY OF THE INVENTION

It is an aim of the present invention to provide a mechanism that does not require programming but still has flexibility when different processes need to support different fields.

According to a first aspect of the present invention there is provided a method for providing a user interface to be applied to a plurality of processes comprising: defining a set of basic fields; providing a set of process fields; for each process field either mapping the process field to a basic field or defining a process-specific field; providing a user interface including the basic fields and process-specific fields.

The plurality of processes may be for example, searchable applications or workflow process steps.

According to a second aspect of the present invention there is provided a system for providing a user interface to be applied to a plurality of processes comprising: a set of basic fields; means for providing a set of process fields; a register which, for each process field, either maps the process field to a basic field or defines a process-specific field; a user interface including the basic fields and process-specific fields.

According to a third aspect of the present invention there is provided a user interface comprising: a set of basic fields for input parameters which define the intersection of the common fields of a plurality of processes; and one or more sets of process-specific fields for input parameters.

According to a fourth aspect of the present invention there is provided a computer program product stored on a computer readable storage medium for providing a user interface, comprising computer readable program code means for performing the steps of: defining a set of basic fields; providing a set of process fields; for each process field either mapping the process field to a basic field or defining a process-specific field; providing a user interface including the basic fields and process-specific fields.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a block diagram of a computer system in which the present invention may be implemented;

FIG. 2A is a block diagram of a search system for searching across heterogeneous applications as known in the prior art;

FIG. 2B is an example of a user interface with fixed fields as provided in the search system of FIG. 2A;

FIG. 3A is a block diagram of a search system in accordance with a first embodiment of an aspect of the present invention;

FIG. 3B is an example of a user interface as provided in the search system of FIG. 3A;

FIG. 4 is a schematic diagram of a search system in accordance with a first embodiment of an aspect of the present invention;

FIG. 5A is a block diagram of a workflow system in accordance with a second embodiment of an aspect of the present invention;

FIG. 5B is a schematic diagram of a workflow in accordance with FIG. 5A;

FIG. 6 is a schematic diagram of a workflow system in accordance with an aspect of the present invention; and

FIGS. 7A to 7C are flow diagram of processes in accordance with aspects of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

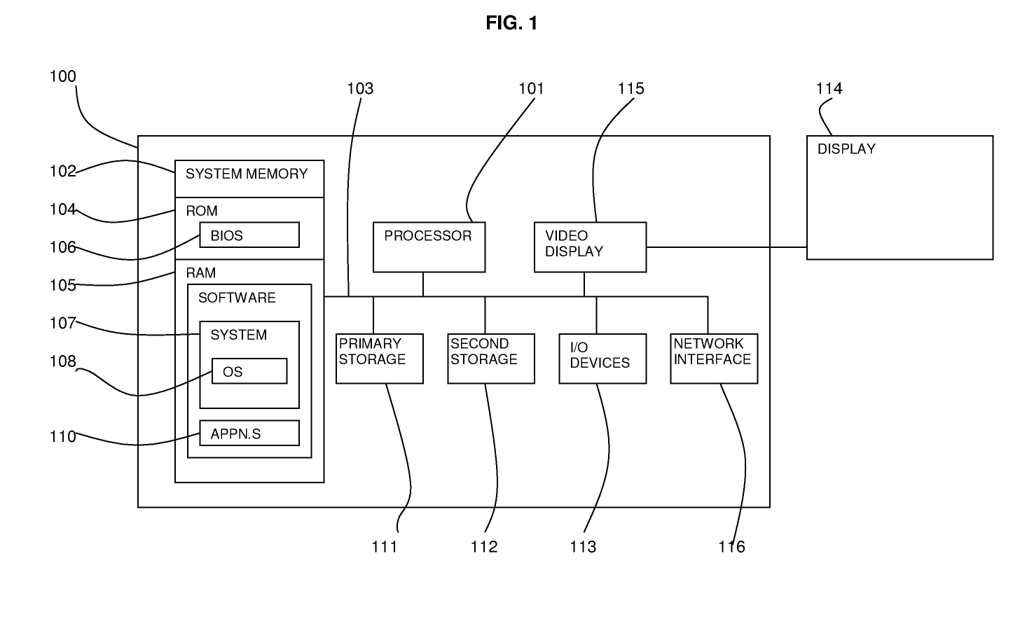

Referring to FIG. 1, an exemplary system for implementing the invention includes a data processing system 100 suitable for storing and/or executing program code including at least one processor 101 coupled directly or indirectly to memory elements through a bus system 103. The memory elements can include local memory employed during actual execution of the program code, bulk storage, and cache memories which provide temporary storage of at least some program code in order to reduce the number of times code must be retrieved from bulk storage during execution.

The memory elements may include system memory 102 in the form of read only memory (ROM) 104 and random access memory (RAM) 105. A basic input/output system (BIOS) 106 may be stored in ROM 104. System software 107 may be stored in RAM 105 including operating system software 108. Software applications 110 may also be stored in RAM 105.

The system 100 may also include a primary storage means 111 such as a magnetic hard disk drive and secondary storage means 112 such as a magnetic disc drive and an optical disc drive. The drives and their associated computer-readable media provide non-volatile storage of computer-executable instructions, data structures, program modules and other data for the system 100. Software applications may be stored on the primary and secondary storage means 111, 112 as well as the system memory 102.

The computing system 100 may operate in a networked environment using logical connections to one or more remote computers via a network adapter 116.

Input/output devices 113 can be coupled to the system either directly or through intervening I/O controllers. A user may enter commands and information into the system 100 through input devices such as a keyboard, pointing device, or other input devices (for example, microphone, joy stick, game pad, satellite dish, scanner, or the like). Output devices may include speakers, printers, etc. A display device 114 is also connected to system bus 103 via an interface, such as video adapter 115.

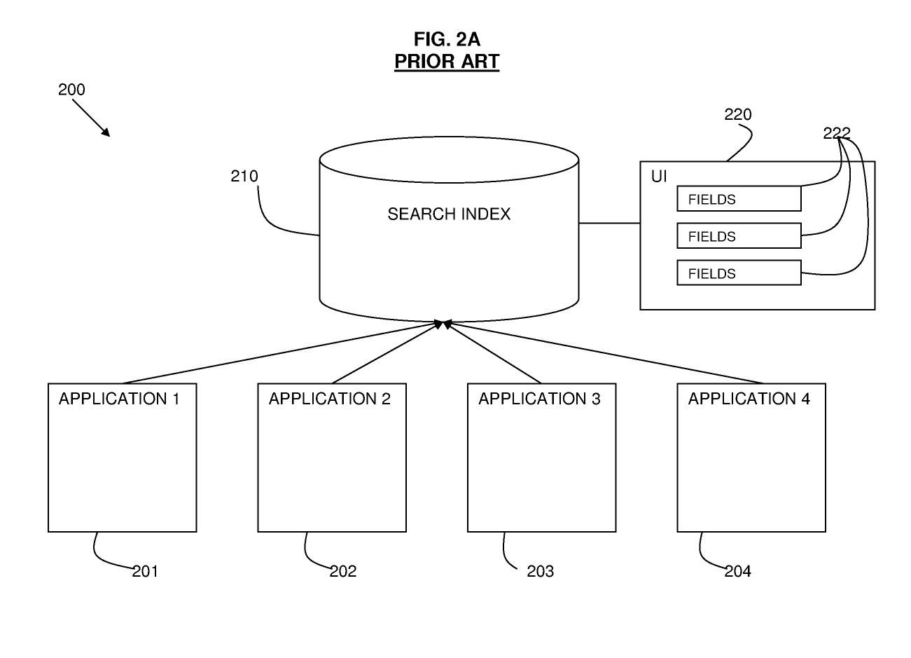

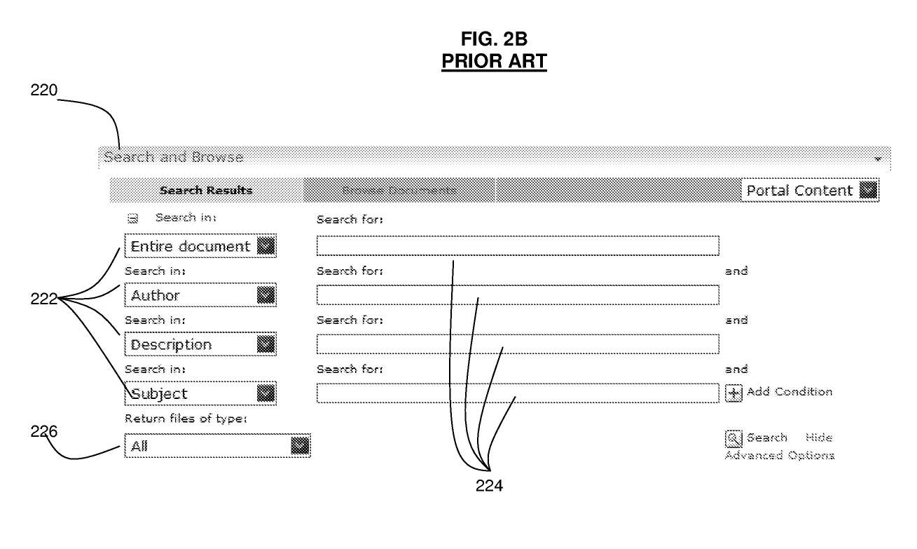

Referring to FIG. 2A, a block diagram shows a computer system 200 with a system-level search index 210 as known in the prior art. A plurality of applications 201-204 share the search index 210. The search index 210 has a published indexing API allowing the applications 201-204 to index their data in the search index 210. The search index has a user interface (UI) 220 with a plurality of fields 222 for inputting search parameters to the search index 210.

FIG. 2B shows a UI 220 with fixed fields 222 as an example of the prior art. The fixed fields 222 are defined for general fields and may have drop down menus for selecting the appropriate parameter. For each fixed field 222, there is an input box 224 for input of the search query text. A selection mechanism 226 is provided for selecting the types of files to be searched.

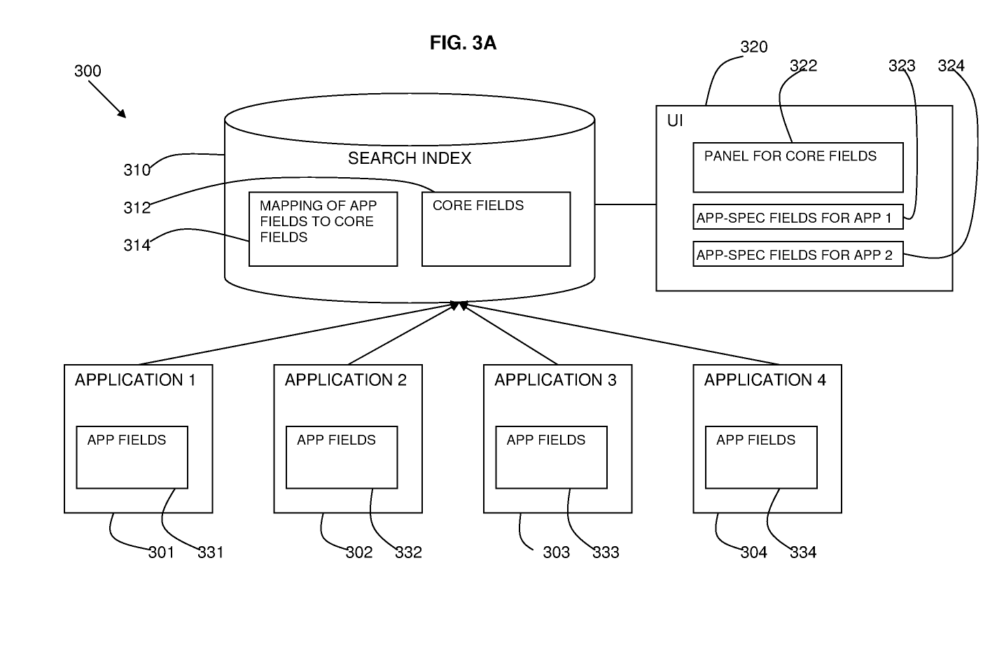

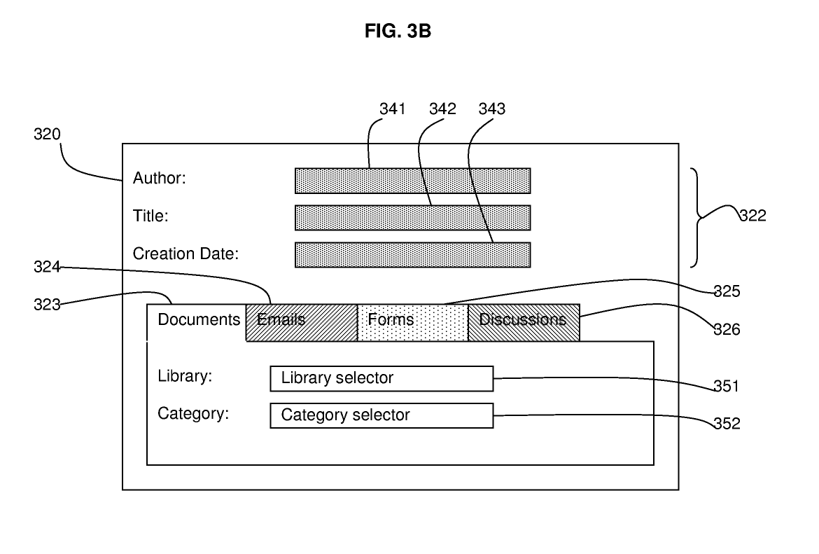

Referring now to FIG. 3A, a block diagram shows a first embodiment of the present invention in the form of a search system 300 with a system-level search index 310. A plurality of application 301-304 have their data searched by the search system 300. The search system 300 has a global search index 310. The search index 310 defines a set of core fields 312. These core fields 312 may be, for example the Dublin Core. The Dublin Core metadata element set is a standard for cross-domain information resource description. Alternatively, the core fields 312 may be defined for the search index 310.

The applications 301-304 each have fields 331-334 for defining the individual application's content. The search index 310 includes a mechanism 314 for mapping the applications' fields 331-334 to the core fields 312. If a mapping of an application field to a core field is not possible, the application field is specific to that application 301-304 and defined individually.

The search system 300 includes a UI 320 for inputting parameters into the fields. The UI 320 includes a panel 322 for inputting parameters into the core fields. In addition, the UI 320 has sub-panels 323, 324 for each application 301-304 that has specific fields 331-334 which cannot be mapped to a core field.

The described system promotes consistency across applications 301-304 and also allows applications 301-304 to define extensions that are specific to the application. Each application 301-304 defines a mapping from their fields to a fixed set of predefined fields and a set of fields specific to the application. The search index 310 stores this information in its metadata.

When the search UI 320 is presented to the end user, the presentation layer queries the search index metadata to determine what applications 301-304 have been registered and what are their specific fields.

The search UI 320 is built by building a panel 322 containing the intersection of the common fields and one or more sub-panels 323, 324 for applications 301-304 containing their specific fields 331-334.

New applications can also input their fields into the search system 300 and the UI 320 changes automatically to integrate such new applications into the search platform.

FIG. 3B shows an example embodiment of a UI 320 in which the core fields have input means 341-343 provided in a panel 322. In addition, extensible sub-panels 323-326 are provided for applications which have specific fields 351, 352. Each sub-panel 323-326 for individual applications may have an option to select that application to be included in a search.

In FIG. 3B, the extensible sub-panels 323-326 are shown as tabbed panels for applications such as documents 323, email application 324, forms 325, and discussions 326. In the document panel 323, specific fields are provided for selecting a library 351 and selecting a category 352 as these fields cannot be mapped to one of the core fields.

Possible alternatives to using a tabbed panel interface is to use a drop down menu, radio buttons, or any other form of single selection interface tool.

When defining their fields 331-334 applications 301-304 should not only define the type of the fields (String, Number, Date, etc.), but also the operations supported for the type (equality, inequality, greater than etc.), the type of widget that must be associated with it, and the type of facet associated with it. For example, a field for an author may require a user selector with an option button for selecting users from a list. Similarly, a language selector may be for example a drop down menu of possible languages.

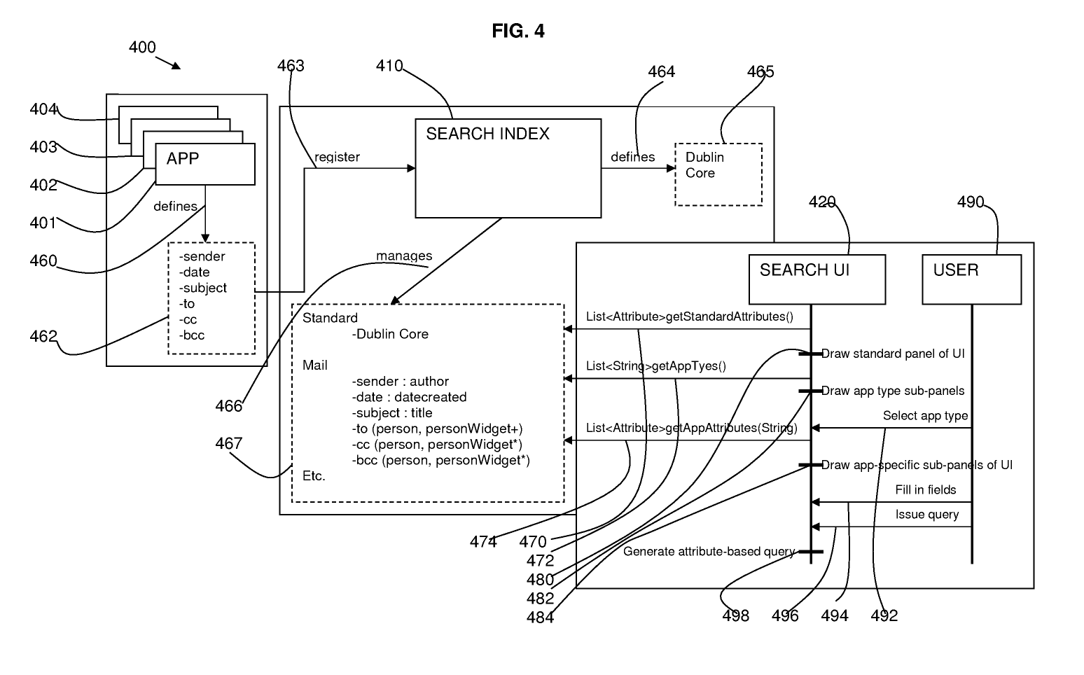

FIG. 4 shows a schematic diagram 400 of the process of generating a UI 420 for a search index 410 for multiple applications 401-404. Each application 401-404 defines 460 its attribute map 462. FIG. 4 shows a mail application 401 which defines an attribute map 462 with the attributes of: “sender”, “date”, “subject”, “to”, “cc”, “bcc”. These attributes 462 are fields which can be searched to locate content in the application 401.

An application 401 registers 463 its attribute map 462 with the search index 410. The search index 410 defines 464 a set of standard attributes 465, for example the Dublin Core attributes.

The search system 400 manages 466 an attribute registry 467. The attribute registry 467 lists the standard attributes and lists the attributes of each application 401-404. The attributes of each application 401-404 are listed with a relationship to a standard attribute, if appropriate. If an application attribute has no relationship to a standard attribute, then the presentation of the application attribute is defined.

In the illustrated example in FIG. 4, the attribute registry 467 shows the attributes for the mail application 401. The mail attribute of “sender” is mapped to the standard attribute of “author”. The mail attribute of “date” is mapped to the standard attribute of “date created”. The mail attribute of “subject” is mapped to the standard attribute of “title”. The mail attribute of “to” does not have a corresponding standard attribute and so the format of this field is defined as (person, personWidget+). Similarly, the mail attributes of “cc” and “bcc” do not have corresponding standard attributes and so the format of these fields is defined as (person, personWidget*).

The search UI 420 is built by listing 470 the standard attributes and creating 480 the standard panel of the UI 420. The application types are then listed 472 and the application type sub-panels are created 482. The application specific attributes are then listed 474 and the application specific fields of the sub-panels are created 484.

A user 490 may then select 492 an application type, fill in the fields 494 and issue a query 496. An appropriate attribute-based query is then generated 498 and submitted to the search index 410.

The above description applies the UI in a search environment as a first embodiment of the present invention.

In a second embodiment, the UI may be applied in the context of workflows. For example, there may be provided a form whose content drives a particular workflow. By allowing the workflow process steps to map entries to the existing form, the form can automatically be modified to handle changes in the workflow.

A workflow is composed from several steps. The steps can be automated or done by humans. Each automated step receives a set of fields and values as input and does some computation and outputs a new set of fields and values. Thus, it can be considered that there is a form that circulates among the states of the workflow. The human driven steps involve presenting the user a set of forms with two types of fields: fields for which values has been obtained in the preceding workflow steps; and fields without a value that the user should fill in order to execute the following steps in the workflow.

Both for automated and human driven steps, the fields can be organized into input and output fields. This is parallel to what has been described in the first embodiment of the search UI form. The fields of the form are mapped to the input expected by each one of the steps of the workflow. If some workflow steps are non-standard, a special entry section can be created for it. The difference between the workflow scenario and the search scenario is that, in the case of search, all the fields of the (search) form are input fields. In the case of the workflow, there are both input and output fields.

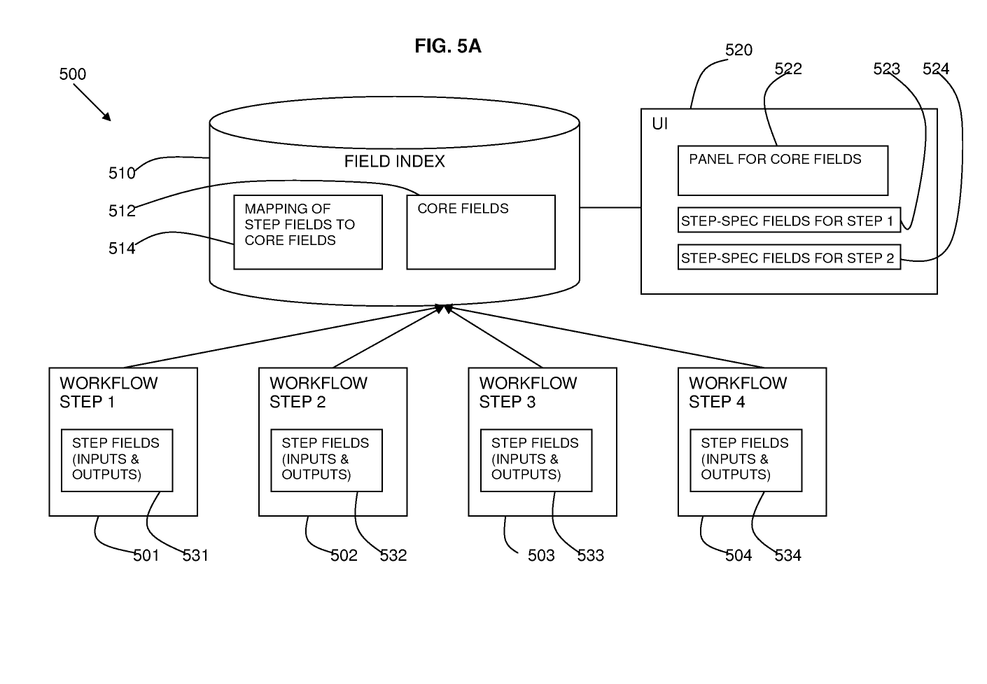

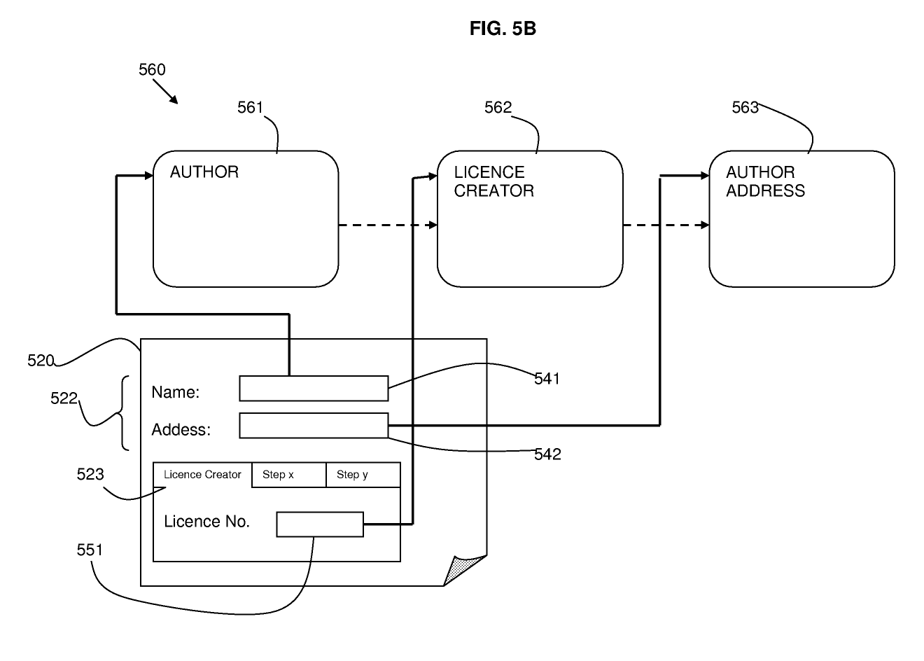

Referring to FIG. 5A, a block diagram shows the second embodiment of a workflow system 500 in which a plurality of workflow process steps 501-504 input or retrieve data to or from a form 520 of the workflow system 500. As discussed above, the workflow process steps 501-504 may be manual or automated. The workflow system 500 maintains a field index 510 which defines a set of core fields 512.

The steps 501-504 each have fields 531-534 for input and outputs of that step of the workflow. The field index 510 includes a mechanism 514 for mapping the steps' fields 531-534 to the core fields 512. If a mapping of a step's field to a core field is not possible, the field is specific to that step 501-504 and defined individually.

The search system 500 includes a form UI 520 for inputting and retrieving parameters from the fields. The UI 520 includes a panel 522 for inputting parameters into the core fields. In addition, the UI 520 has sub-panels 523, 524 for each step 501-504 that has specific fields 531-534 which cannot be mapped to a core field.

When the form UI 520 is presented to the user, the presentation layer queries the field index metadata to determine what steps 501-504 have specific fields.

FIG. 5B shows a workflow 560 created with three steps 561-563. Each step 561-563 of the workflow 560 expects input from a form 520. In FIG. 5B, the workflow 560 is linear but non-linear workflows may also be created.

The first step 561 expects an author input. This input is mapped to a standard input field 541 for a name and therefore the field is provided in the main panel 522 of the form 520.

The second step 562 expects an input of a license number. This is a specific field for this step of the workflow. Therefore, a specific field 551 is provided in a sub-panel 523 for this step. The value of this field may be entered by a human operator or may have been computed in the first step 561 of the workflow, in which case it is an output field of the first step 561.

The third step 563 expects an input of the author's address. This input is mapped to a standard input field 542 provided in the main panel 522 of the form 520. The value of this field may have been output by the previous steps of the workflow or may be entered by a human operator.

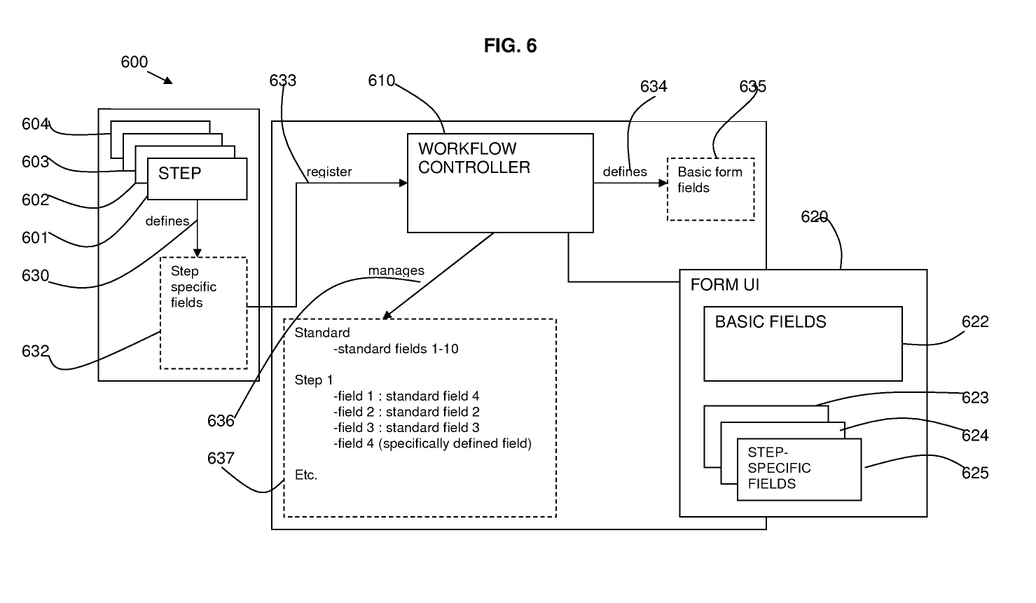

This embodiment is shown in FIG. 6 which corresponds to FIG. 4 but in the context of workflows instead of searches. A workflow system 600 includes a workflow controller 610 which has a UI 620 as a form with inputs in entry fields of the form.

Multiple process steps 601-604 can define 630 step-specific entries 632 which are registered 633 with the workflow controller 610. The workflow controller 610 defines 634 basic form entries 635.

The workflow controller 610 also manages 636 an entry register 637 which maps the step-specific entries 632 to the basic entries 635 where possible and defines the step-specific entries which do not have a mapping.

The UI from 620 has a panel of basic entries 622 and sub-panels for step-specific entries 623, 624, 625.

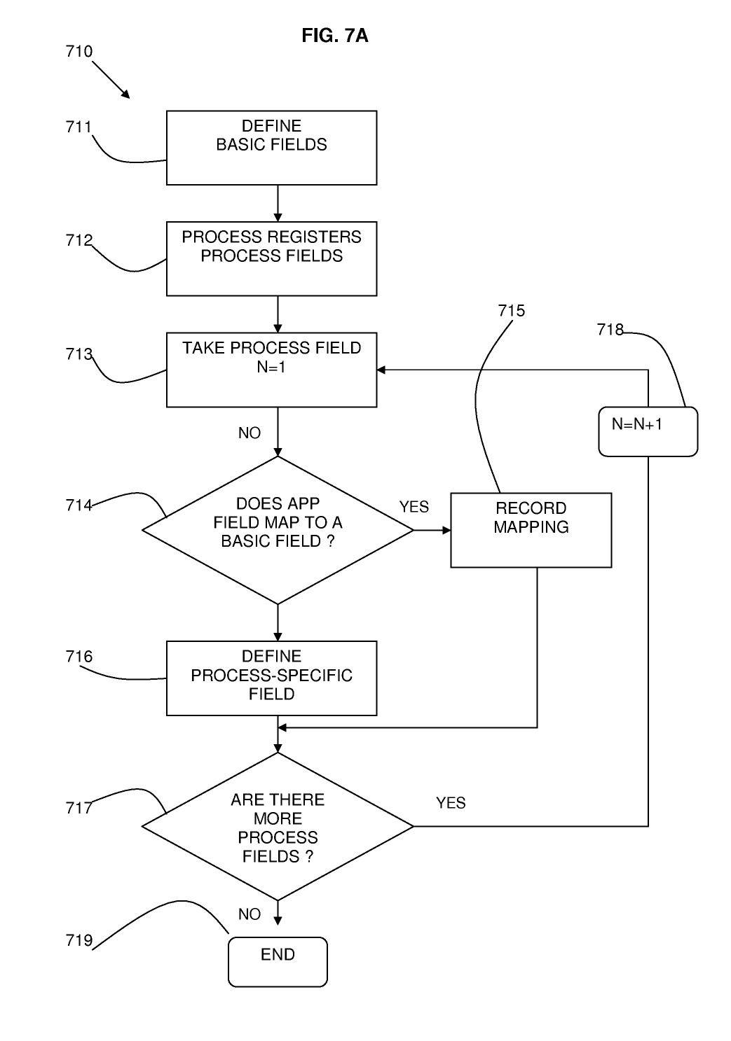

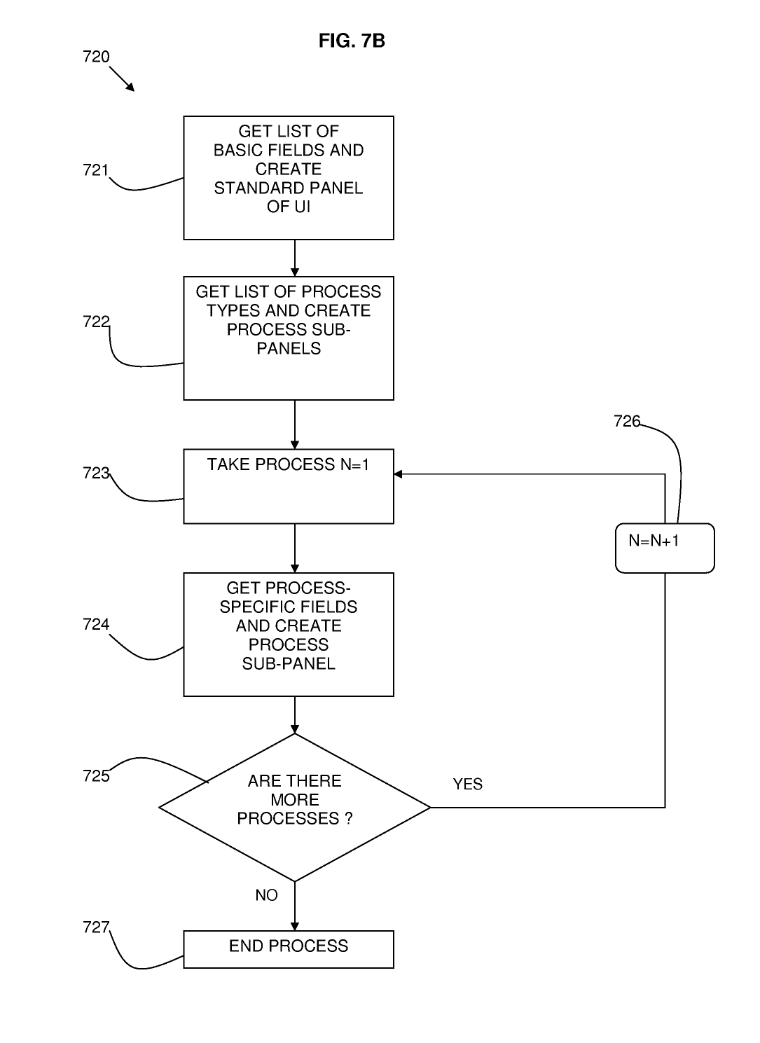

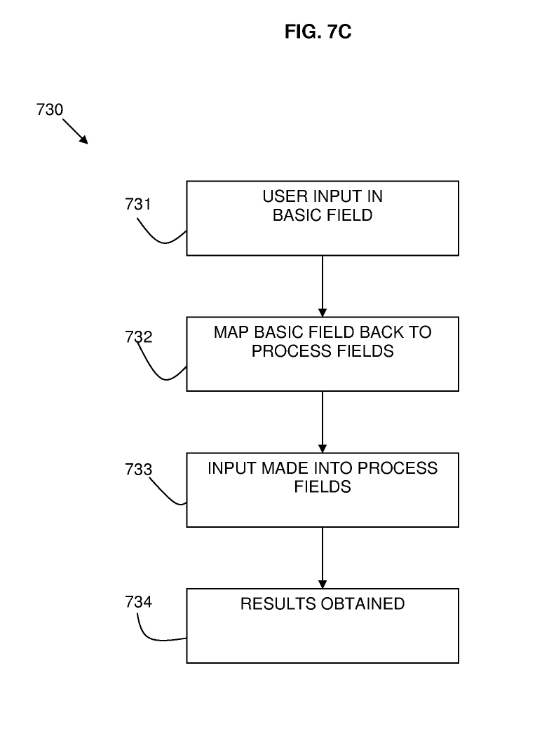

FIGS. 7A to 7C are flow diagrams of the methods involved in the embodiments of the present invention.

FIG. 7A is a flow diagram 710 of the method steps carried out to define the fields, for example, by the search index of the first embodiment or by the workflow controller of the second embodiment. The applications of the first embodiment and the process steps of the second embodiment which both register fields, are generally referred to as processes with process fields.

Firstly, the basic fields are defined 711. A process registers 712 its fields. A first (n=l) field is processed 713 and it is determined 714 if the field maps to a basic field. If there is a basic field to which the process field maps, then the mapping is registered 715. If there is not a basic field corresponding to the process field, then the process field is defined 716 as a process-specific field.

It is then determined 717 if there is a next process field to process. If so, the method loops 718 (n=n+1) and repeats for the next process field. If there are no more process fields, the method ends 719.

FIG. 7B is a flow diagram 720 of the method steps carried out to create a UI. A list of the basic fields is obtained and the basic fields panel of the UI is created 721. The list of the process (applications or workflow steps) types is obtained and the sub-panels for each of the processes are created 722. For a first process (n=1) 723 the process-specific fields are obtained and the fields of the first process sub-panel are created 724. It is determined 725 if there is a next process. If so, the method loops 726 (n=n+1) and the next sub-panel fields are created. If there are no more processes, the method ends 727.

FIG. 7C is a flow diagram 730 of the method steps carried out when a user inputs entries into the fields of the UI. A user makes an input 731 into a basic field. The basic field is mapped back to the process fields 732. The input is made into the mapped process fields 733 and the results obtained 734 from the processes.

In the first embodiment of the search system, a query input into a basic field is translated into query inputs into each of the application fields which are mapped to this basic field. The search is carried out of each application with an application field mapped to this basic field and the results obtained.

In the second embodiment of the workflow system, an input or output entry into a basic field in the form is translated into an input or an output entry for each workflow step entry mapped to the basic field. The workflow step is then run with the input or output entry.

A UI system and method may be provided as a service to a customer over a network.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

We claim:

1. A method for providing a user interface to be applied to a plurality of processes comprising:
defining a set of basic fields;
providing a set of process fields;
for each process field either mapping the process field to a basic field or defining a process-specific field;
providing a user interface including the basic fields and process-specific fields.

2. The method as claimed in claim 1, wherein defining the process-specific field includes one or more of defining the type of field, associated widgets, associated facets, and supported operations.

3. The method as claimed in claim 1, including adding a new process by providing a set of process fields, and extending the user interface to include the new process fields.

4. The method as claimed in claim 1, wherein the user interface is a search interface, the fields are metadata fields for defining search parameters, and the processes are applications to be searched.

5. The method as claimed in claim 4, including generating a search based on inputs into the basic fields and the process-specific fields in the form of application-specific fields.

6. The method as claimed in claim 5, wherein an input into a basic field is mapped back to the application fields and the relevant applications are searched.

7. The method as claimed in claim 1, wherein the user interface is a workflow form interface, the fields are entries for defining workflow inputs and outputs, and the processes are workflow steps.

8. The method as claimed in claim 7, wherein the workflow form is automatically modified in response to a process providing a set of process fields of entries for defining workflow inputs or outputs.

9. A system for providing a user interface to be applied to a plurality of processes comprising:
a set of basic fields;
means for providing a set of process fields;
a register which, for each process field, either maps the process field to a basic field or defines a process-specific field;
a user interface including the basic fields and process-specific fields.

10. The system as claimed in claim 9, wherein the register defines the process-specific fields and includes one or more of defining the type of field, associated widgets, associated facets, and supported operations.

11. The system as claimed in claim 9, including means for adding a new process by providing a set of process fields, and means for extending the user interface to include the new process fields.

12. The system as claimed in claim 9, wherein the user interface is a search interface, the fields are metadata fields for defining search parameters, and the processes are applications to be searched.

13. The system as claimed in claim 12, including means for generating a search based on inputs into the basic fields and the process-specific fields.

14. The system as claimed in claim 13, including means for mapping an input into a basic field back to the process field.

15. The system as claimed in claim 9, wherein the user interface is a workflow form interface, the fields are entries for defining workflow inputs or outputs, and the processes are workflow steps.

16. The system as claimed in claim 15, wherein the workflow form is automatically modified in response to a process providing a set of process fields of entries for defining workflow inputs or outputs.

17. A user interface comprising:
a set of basic fields for input parameters which define the intersection of the common fields of a plurality of processes; and
one or more sets of process-specific fields for input parameters.

18. The user interface as claimed in claim 17, wherein the one or more sets of process-specific fields are provided as sub-panels for each process, each sub-panel including the process-specific fields for one process.

19. The user interface as claimed in claim 18, wherein the sub-panels are extensible from the user interface when selected.
